(19) United States
(12) Patent Application Publication
(10) Pub. No.: US 2024/0362599 A1
(43) Pub. Date: Oct. 31, 2024

(54) SYSTEMS AND METHODS FOR USE IN PROVISIONING TOKENS FOR UNSUPPORTED ACCOUNTS

(71) Applicant: MASTERCARD INTERNATIONAL INCORPORATED, PURCHASE, NY (US)

(72) Inventors: Vairag Jain, Jersey City, NJ (US); Vijin Venugopalan, Pleasanton, CA (US); Jae-Youl Yang, Seoul (KR)

(21) Appl. No.: 18/642,694

(22) Filed: Apr. 22, 2024

Related U.S. Application Data
(60) Provisional application No. 63/462,941, filed on Apr. 28, 2023.

(51) Int. Cl. G06Q 20/10; G06Q 20/36

(52) U.S. Cl. CPC G06Q 20/108; G06Q 20/36

(57) ABSTRACT

Disclosed are example embodiments of systems and methods for provisioning and/or using tokens for unsupported accounts. In an example embodiment, a method generally includes receiving, by a token host computing device, from a wallet application in a mobile device, a provisioning request to provision a token for an account, where the account is unsupported by the wallet application. The method also includes generating a token for the account and storing the token in a memory in association with an account number for the account. The method then further includes returning the token to the wallet application, whereby the token is stored in the mobile device for use in initiating transactions to the account.

### CROSS-REFERENCE TO RELATED APPLICATION

This application claims the benefit of, and priority to, U.S. Provisional Application No. 63/462,941, filed Apr. 28, 2023. The entire disclosure of the above application is incorporated herein by reference.

### FIELD

The present disclosure generally relates to systems and methods for provisioning and using tokens for unsupported accounts, to provide accessibility to digital activity services based thereon.

### BACKGROUND

This section provides background information related to the present disclosure which is not necessarily prior art.

Different types of accounts are known to be used by users in connection with network transactions. The accounts may include credit accounts, debit accounts, prepaid accounts, etc. The accounts are generally associated with or branded to a processing network, which participates in messaging indicative of the network transactions as directed by different participants of the network transactions. The processing networks further coordinate and manage transfers of funds required by the network transaction.

### BRIEF DESCRIPTION OF DRAWINGS

The drawings described herein are for illustrative purposes only of selected embodiments and not all possible implementations and are not intended to limit the scope of the present disclosure.

FIG. 1 is a block diagram of an example system of the present disclosure suitable for use in provisioning and using tokens for unsupported accounts;

FIG. 2 is a block diagram of an example computing device, that may be used in the system of FIG. 1;

FIG. 3 is an example method that may be implemented in the system of FIG. 1, or otherwise, for provisioning tokens for an unsupported account to a digital activity service of a mobile device; and

FIG. 4 is an example method that may be implemented in the system of FIG. 1, or otherwise, for using tokens for an unsupported account.

Corresponding reference numerals indicate corresponding parts throughout the several views of the drawings.

### DETAILED DESCRIPTION

Example embodiments will now be described more fully with reference to the accompanying drawings.

Accounts are generally offered by issuers, who coordinate with processing networks to support the accounts issued by the issuers. Beyond the processing networks, the accounts may be unsupported by services associated with use of the accounts. For example, wallet applications and/or servers are used to provision accounts to mobile devices, whereby the mobile devices are used to present the accounts (e.g., as tokens, etc.), rather than physical cards issued with the accounts. In connection therewith, certain accounts may be unsupported for the services, based on account numbers associated with the accounts, while other, different account numbers associated with other, different accounts are supported. Unsupported accounts are limited, then, in presentment options as it relates to such services, which then impacts overall acceptance of the accounts. The inventors hereof have recognized the need for a technical solution to extend the support of the services to otherwise unsupported accounts.

Uniquely, the systems and methods herein provide for tokenization of the unsupported accounts, whereby the tokens are generated in a form that is supported by the digital activity services. In particular, an account may be unsupported based on lack of conformance to one or more standards, whereby a digital activity service (e.g., a wallet service, etc.) may be accessible based on a tokenization of the account consistent with the one or more standards. As such, a token host may generate a token, having a specific format which is supported for the digital activity service, whereby the digital activity service is accessible through the token. In this manner, the account, while unsupported, is associated with extended functionality through the tokenization, which provides for efficient and convenient access to the service(s), etc.

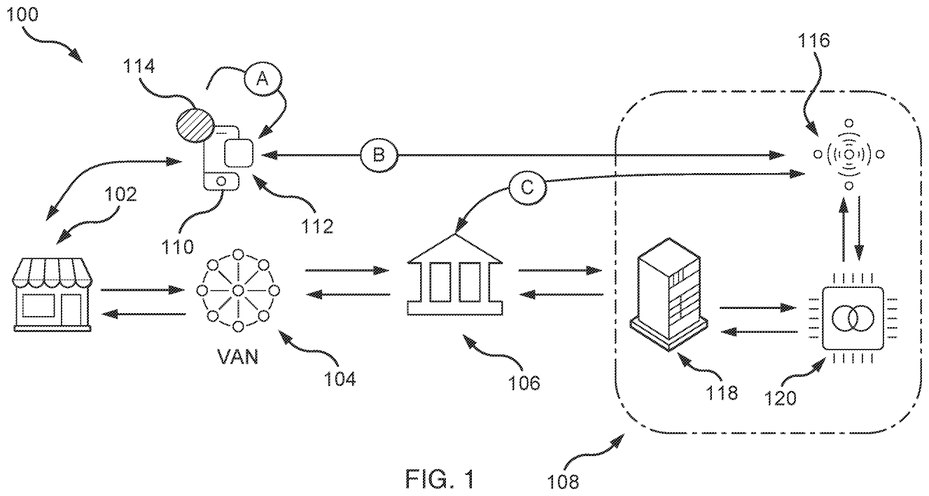

FIG. 1 illustrates an example system 100, in which one or more aspects of the present disclosure may be implemented. Although, in the described embodiment, parts of the system 100 are presented in one arrangement, other embodiments may include the same or different parts arranged otherwise, depending, for example, on tokenization, standards associated with accounts, types of activity services and/or processing networks, privacy rules or regulations, etc.

Referring to FIG. 1, the system 100 generally includes a first party 102, a value-added network (VAN) 104, an issuer processor 106, and a processing network 108, each of which is coupled in communication via one or more networks, as indicated by the arrowed lines. The one or more networks may include, without limitation, one or more of a local area network (LAN), a wide area network (WAN) (e.g., the Internet, etc.), a mobile network, a virtual network, and/or another suitable public and/or private network capable of supporting communication among two or more of the components illustrated in FIG. 1, or even combinations thereof.

In this example, the first party 102 includes a merchant, which is configured to offer products, such as goods or services, etc., for sale to users. The first party 102 is further configured to accept different types of accounts to fund transactions for the products, including, in this example, accounts issued by the issuer processor 106. The first party 102 is configured to communicate with the VAN 104 in connection with such transactions.

The VAN 104, in turn, is configured to communicate with the first party 102 and also the issuer processor 106, to provide messaging related to the transactions. In this manner, the VAN 104 is configured to communicate with numerous first parties (not shown). And, the VAN 104 may be specific to the issuer processor 106, or service a number of different issuer processors.

The issuer processor 106 is configured to issue accounts to users, which may be used, via the VAN 104, to fund transactions. Specifically, the issuer processor 106 is configured to issue accounts, which each have unique account numbers. The account numbers are defined by the issuer processor 106 and/or are specific to the issuer processor 106. What's more, the issuer processor 106 provides for a closed-loop network for the accounts, whereby the issuer processor 106 is consistent with both an acquiring bank and an issuer bank in conventional transactions (i.e., the issuer processor 106 is the issuer of both accounts to the transactions). In this example, the accounts are therefore not associated with other standards of conventional processing networks, such as, for example, ISO-standard processing networks (e.g., Mastercard, VISA, DISCOVER etc., processing networks, etc.) and/or are inconsistent with, for example, the ISO/IEC 7812 standard, etc.

As indicated above, each account is associated with an account number, and the account numbers, in this example, include a bank identification number or BIN, which is 9XXX (i.e., a leading digit of 9 with additional numbers hereafter). It should be appreciated that content, size, format, etc., of the BIN may be different in other embodiments.

In connection with a transaction at the first party 102, the first party 102 is configured to receive the account number for an account from a user (e.g., by presenting a payment card to be swiped or tapped at a terminal, etc.) and to transmit an authorization request for the transaction to the VAN 104. The VAN 104, in turn, is configured to coordinate switching of the transaction for the closed-loop network of the issuer processor 106 (and/or multiple closed-loop networks). In connection therewith, the VAN 104 is configured to receive the authorization request, to identify the issuer processor 106 based on the account number (and specifically, the BIN), and to forward the authorization request for the transaction to the issuer processor 106.

The issuer processor 106 is configured to then identify the account based on the account number, to decide to approve or decline the transaction based on various criteria, and to transmit an authorization reply back to the first party 102, via the VAN 104.

Additionally, the system 100 includes a mobile device 110, which is associated with a user (not shown). The mobile device 110 may include, for example, a smartphone, a tablet, a smartwatch/wearable, or other suitable mobile device, which may be carried with the user. As shown, the mobile device 110 is associated with a digital activity service, which in this embodiment, includes a digital wallet. Specifically, the mobile device 110 includes a wallet application 112, which configures the mobile device 110 to perform as a payment device (e.g., to present payment credentials to the first party 102, etc.). The wallet application 112 may include, without limitation, PayPass™ from Mastercard™, ApplePay™ from Apple, Pay Wave™ from Visa, GooglePay by Google, etc. In addition, the mobile device 110 also includes an issuer application 114, which is provided from and/or associated with the issuer processor 106. The issuer application 114 configures the mobile device 110 to show balances, transaction details, etc., associated with the account of the user associated with the mobile device 110.

It should be appreciated that the account issued by the issuer processor 106 to the user is associated with an account number, and that the account (and account number) is generally unsupported by the wallet application 112, for example, based on the accounts being not ISO-standard accounts in this example. That is, the wallet application 112 does not support provisioning the account to the wallet application 112 (e.g., based on the account number, and specifically, the BIN thereof, indicative of a non-ISO standard account, etc.). In this way, the account is unsupported by the wallet application 112. Broadly, due to the closed-loop network of accounts issued by the issuer processor 106, the accounts are unsupported for digital activity customers (e.g., ApplePay™ from Apple, PayWave™ from Visa, GooglePay by Google, etc.), for example, because those services are not specifically configured to accommodate the accounts.

With continued reference to FIG. 1, the processing network 108 is illustrated as including different components/parts, which are configured to cooperate with one another as described herein. In particular, in this exemplary embodiment, the processing network 108 includes a token host 116 (e.g., which may include digital services, such as, for example, MASTERCARD digital enablement service (MDES), etc.), an access server 118 (e.g., which may include MASTERCARD Direct Service Access (DSA), etc.), and an authorization platform 120 (e.g., which may include the MASTERCARD authentication platform, etc.), which are configured as described below.

It should be appreciated that one or more of the above may be integrated with one another, or still further components/parts may be included as part of the processing network 108 to provide the configurations described herein.

That said, in this exemplary embodiment, despite an example account issued by the issuer processor 106 to a user being unsupported, the user (not shown) to which the account is issued may provision the account to the wallet application 112, through the token host 116 included in the processing network 108. In particular, to provision the account, the mobile device 110 is configured, by the issuer application 114, to call an application programming interface (API) associated with the wallet application 112 (or potentially, a wallet server (not shown)), as indicated at A. In that call, the issuer application 114 provides the account number for the account (i.e., 9XXX) as a financial account identifier (which is designated as different than or from a card account number field), an identifier of the issuer processor 106, and a country code.

While an API call is specifically referenced in this example, it should be appreciated that the mobile device 110 may be configured otherwise to submit the request to the wallet application 112, or associated server, to provision the account.

Based on the request, the mobile device 110 is configured, by the wallet application 112, to submit a provisioning request to the token host 116, as indicated at B. The provisioning request includes the account number for the account (i.e., 9XXX), an identifier of the issuer processor 106, a country code, and a wallet identifier specific to the wallet application 112 in the mobile device 110. In response, the token host 116 is configured to verify the issuer processor 106 is enrolled for tokenization and to verify the country code (e.g., to verify a domestic tokenization, etc.). Once verified, the token host 116 is configured to generate a pseudo account number or PAN for the account. The pseudo PAN is generally an account number (e.g., funding primary account number (FPAN), etc.) associated with and/or supported by the processing network 108 (i.e., within an allocated BIN range assigned to the processing network 108), which may enable the processing network 108, in general, to issue/assign a token for the account. In this specific example, the pseudo PAN includes a BIN having a value of either 5XXX or 2XXX. In general, the token host 116 (or more generally, the processing network 108) is further configured to allocate the BIN range to the issuer processor 106, whereby accounts issued by the issuer processor 106 (which are seeking tokenization) are assigned pseudo PANs (and also tokens) within that allocated range. It should be appreciated that the BIN may be otherwise in other embodiments.

In connection with the above, the token host 116 is further configured to identify the issuer processor 106 based on the identifier and to submit a request for permission to provision the account. The request includes the pseudo PAN and the account number 9XXX.

The issuer processor 106, in response, is configured to approve or decline the request for permission. As part thereof, the issuer processor 106 may be configured to authenticate the user at the mobile device 110, through the issuer application 114, through a one-time-passcode, or otherwise, etc. When approved, the issuer processor 106 is configured to respond to the request for permission with an approval. It should be appreciated that the issuer processor 106 may shift the authentication associated with approval, in whole or in part, to the token host 116.

Based on the approval of the request for permission, the token host 116 is configured to generate and/or activate a token specific to the pseudo PAN. The token, like the pseudo PAN, in this example, includes a BIN having a value of either 5XXX or 2XXX, which is supported by the wallet application 112. The token host 116 is configured to store the 9XXX account number, the pseudo PAN, the token, and the wallet identifier, as linked to one another (e.g., in a mapping data structure, etc.), as a record in memory. And, the token host 116 is also configured to communicate the token back to the mobile device 110 and also to the issuer processor 106. Because the BIN is supported by the wallet application 112, the mobile device 110 is configured to store the token therein, whereby the token is provisioned to the wallet application 112. To be clear, based on the above, the unsupported account from the issuer processor 106 is provisioned to the wallet application 112, through the use of the token, which is supported.

Further, the token host 116 and/or the issuer processor 106 may be configured to notify the VAN 104 that the BIN for the token is associated with the issuer processor 106, or potentially, that a BIN range is associated with the issuer processor 106. The VAN 104 in turn is configured to update a ledger of BINs and associated issuer processors in memory thereof.

Next, in connection with a transaction, as directed by the user (e.g., through a tap at a terminal of the first party 102, etc.), the mobile device 110 is configured, by the wallet application 112, to provide the token to the first party 102. The first party 102 is configured, in turn, to compile an authorization request for the transaction, which includes the token and other transaction details (e.g., amount, first party identifier, country code, currency, time/date, etc.), and to transmit the authorization request to the VAN 104. In turn, the VAN 104 is configured to identify the issuer processor 106 based on the token (and the ledger of BINs and associated issuer processors) and to forward the authorization request to the issuer processor 106.

Upon receipt, the issuer processor 106 is configured to identify the token, which is not an account number native to the issuer processor 106 (i.e., 9XXX account number) and to forward the token to the access server 118. The access server 118 is configured to submit a de-tokenization call (including the token) to the authorization platform 120. The authorization platform 120 is configured to submit the de-tokenization request including the token to the token host 116. The token host 116 is configured to retrieve the record for the token and to identify the 9XXX account number, the pseudo PAN and the wallet identifier specific to the token.

The token host 116 is configured to return the 9XXX account number, the pseudo PAN and the wallet identifier to the authorization platform 120, which returns the same to the access server 118. It should be appreciated that at this point, or prior, the authorization platform 120 and/or the access server 118 may be configured to perform one or more on-behalf-of services (e.g., fraud scoring, validation, authentication, etc.) for the transaction based on the pseudo PAN, token, etc. The access server 118 is configured to then compile an authorization response (including the 9XXX account number, the pseudo PAN, the token, and the wallet identifier, and potentially, any result from on-behalf-of services, etc.) and to return the authorization response to the issuer processor 106. The issuer processor 106 is configured to proceed with the transaction based on the 9XXX account number, whereby the transaction is either approved or declined. The issuer processor 106 is configured to compile and transmit the authorization reply to the first party 102, through the VAN 104, and also indicate the same to the processing network 108 for purposes of transaction history, as necessary or desired.

In connection with the provisioning of the token to the wallet application 112, it should be appreciated that the token and/or 9XXX account number may be refreshed and/or changed from time to time (e.g., based on expiration, etc.). In various examples, the token may have a change in status, as one of activated, deactivated, suspended or unsuspended, etc., by the issuer processor 106. In connection therewith, the issuer processor 106 is configured to submit a change in status to the token host 116. The change in status may be submitted, via an API, exposed by the token host 116, etc. The change in status may include the token. In turn, the token host 116 is configured to update the status in the wallet application 112 of the mobile device 110, whereby the status is effected.

In other examples, the issuer processor 106 may issue a new or updated account number for the account, i.e., 9XXX account number, etc. In connection therewith, the issuer processor 106 is configured to submit an update account number request to the token host 116. The update account number request may be submitted, via an API, exposed by the token host 116, etc. The request may include the token and also the new and old account numbers, etc. In turn, the token host 116 is configured to store the new account number in the record associated with the token or old account number and to provide the last characters of the new account number to the wallet application 112 of the mobile device 110. In turn, the mobile device 110, as configured by the wallet application 112, shows the account associated with the new characters for the user to select (i.e., accounts in the wallet application 112 may be identified by the last characters of the account number, etc.).

It should be appreciated that other life cycle features and/or functionality associated with the account, token, etc., may be provided between the issuer processor 106, the token host 116, and the mobile device 110, etc.

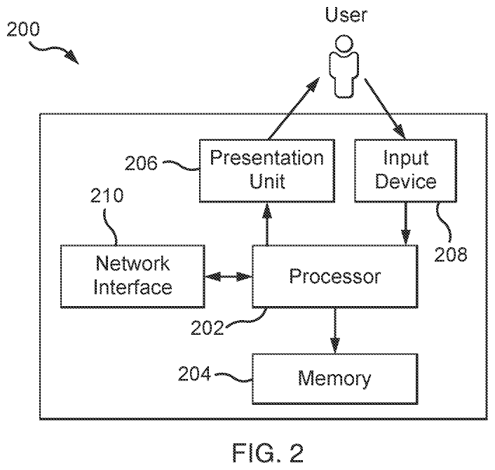

FIG. 2 illustrates an example computing device 200 that may be used in the system 100. The computing device 200 may include, for example, one or more servers, workstations, computers, laptops, tablets, smartphones, virtual devices, etc. In addition, the computing device 200 may include a single computing device, or it may include multiple computing devices located in close proximity or distributed over a geographic region, so long as the computing devices are specifically configured to operate as described herein. In the example embodiment of FIG. 1, at the least, the first party 102, the VAN 104, the issuer processor 106, the token host 116, the access server 118 and the authorization platform 120 may each include and/or may be implemented in one or more computing devices consistent with computing device 200. In addition, the mobile device 110 may be a computing device at least partially consistent with the computing device 200 (or a part thereof, such as, for example, memory 204, etc.). However, the system 100 should not be considered to be limited to the computing device 200, as described below, as different computing devices and/or arrangements of computing devices may be used. In addition, different components and/or arrangements of components may be used in other computing devices.

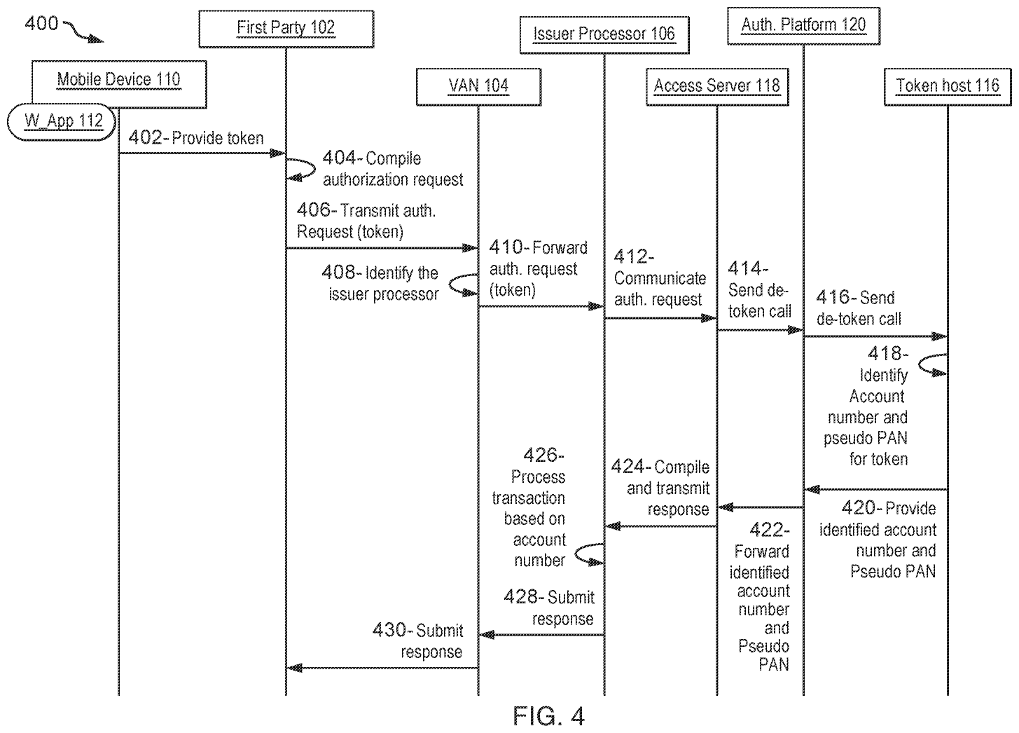

As shown in FIG. 4, the example computing device 200 includes a processor 202 and a memory 204 coupled to (and in communication with) the processor 202. The processor 202 may include one or more processing units (e.g., in a multi-core configuration, etc.). For example, the processor 202 may include, without limitation, a central processing unit (CPU), a microcontroller, a reduced instruction set computer (RISC) processor, a graphics processing unit (GPU), an application specific integrated circuit (ASIC), a programmable logic device (PLD), a gate array, and/or any other circuit or processor capable of the functions described herein.

The memory 204, as described herein, is one or more devices that permit data, instructions, etc., to be stored therein and retrieved therefrom. In connection therewith, the memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other types of volatile or nonvolatile physical or tangible computer-readable media for storing such data, instructions, etc. In particular herein, the memory 204 is configured to store data including, without limitation, tokens, account number, wallet identifiers, pseudo PANs, records, ledgers, and/or other types of data (and/or data structures) suitable for use as described herein.

Furthermore, in various embodiments, computer-executable instructions may be stored in the memory 204 for execution by the processor 202 to cause the processor 202 to perform one or more of the operations described herein (e.g., one or more of the operations of method 300 or 400, etc.) in connection with the various different parts of the system 100, such that the memory 204 is a physical, tangible, and non-transitory computer readable storage media. Such instructions often improve the efficiencies and/or performance of the processor 202 that is performing one or more of the various operations herein, whereby such performance may transform the computing device 200 into a special-purpose computing device. It should be appreciated that the memory 204 may include a variety of different memories, each implemented in connection with one or more of the functions or processes described herein.

In the example embodiment, the computing device 200 also includes a presentation unit 206 that is coupled to (and is in communication with) the processor 202 (however, it should be appreciated that the computing device 200 could include output devices other than the presentation unit 206, etc.). The presentation unit 206 may output information, visually or otherwise, to a user of the computing device 200, etc. It should be further appreciated that various interfaces (e.g., as defined by network-based applications, websites, etc.) may be displayed at computing device 200, and in particular at presentation unit 206, to display certain information to the user. The presentation unit 206 may include, without limitation, a liquid crystal display (LCD), a light-emitting diode (LED) display, an organic LED (OLED) display, an “electronic ink” display, speakers, etc. In some embodiments, presentation unit 206 may include multiple devices. Additionally or alternatively, the presentation unit 206 may include printing capability, enabling the computing device 200 to print text, images, and the like on paper and/or other similar media.

In addition, the computing device 200 includes an input device 208 that receives inputs from the user (i.e., user inputs (e.g., instruction to provision an unsupported account, etc.)), etc. The input device 208 may include a single input device or multiple input devices. The input device 208 is coupled to (and is in communication with) the processor 202 and may include, for example, one or more of a keyboard, a pointing device, a mouse, a touch sensitive panel (e.g., a touch pad or a touch screen, etc.), or other suitable user input devices. It should be appreciated that in at least one embodiment an input device 208 may be integrated and/or included with a presentation unit 206 (e.g., a touchscreen display, etc.).

Further, the illustrated computing device 200 also includes a network interface 210 coupled to (and in communication with) the processor 202 and the memory 204. The network interface 210 may include, without limitation, a wired network adapter, a wireless network adapter, a mobile network adapter, or other device capable of communicating to one or more different networks (e.g., one or more of a local area network (LAN), a wide area network (WAN) (e.g., the Internet, etc.), a mobile network, a virtual network, and/or another suitable public and/or private network capable of supporting wired and/or wireless communication among two or more of the parts illustrated in FIG. 1, etc.), including with other computing devices used as described herein.

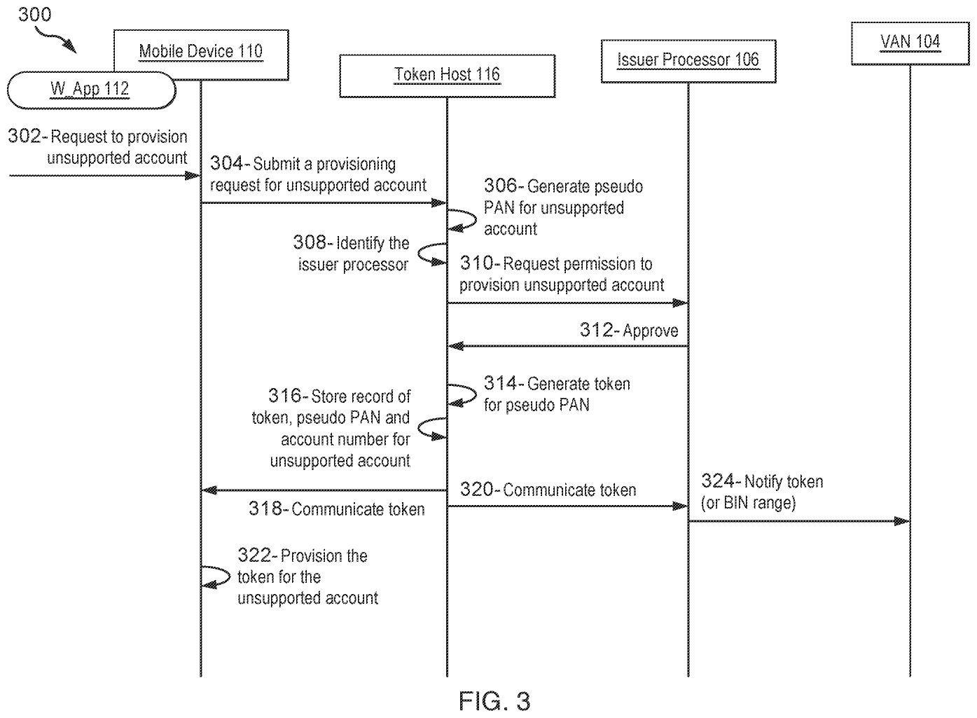

FIG. 3 illustrates an example method 300 for use in provisioning tokens for an unsupported account to an application of a mobile device. The example method 300 is described herein in connection with the system 100, and is also described with reference to computing device 200. However, it should be appreciated that the methods herein are not limited to the system 100, or computing device 200. And, likewise, the systems and computing devices described herein are not limited to the example method 300.

At the outset, it should be understood that the issuer processor 106 has issued an account to the user, and the account is associated with an account number 9343-XXX. It should also be appreciated that the issuer processor 106 is not associated with the wallet application 112 or the wallet provider thereof and the account number is not consistent with one or more applicable standards (e.g., applicable ISO standard, etc.). As such, the account issued by the issuer processor 106 is generally considered unsupported by the wallet application 112, as determined, for example, by the leading 9434 characters of the account number.

In connection with provisioning the account to the wallet application 112, therefore, at 302, then, the mobile device 110 receives a request to provision the account to the wallet application 112, where the request includes the 9434-XXX account number for the account, an identifier of the issuer processor 106 and other suitable data associated with the account (e.g., a country code), the mobile device 110, the wallet application 112, etc. It should be appreciated that the 9434-XXX account number is included in a field designated to identify the account, for example, in an account identity field, i.e., financialAccountId, which is separate than a conventional account number or card number field in the request to provision. In this manner, the mobile device 110, as configured by the wallet application 112, is informed of the unsupported account and, generally, will not reject the account provisioning immediately as unsupported. The request may be received via an API (e.g., from the issuer application 114 based on a user input thereto, etc.), from the user of the mobile device 110 directly in the wallet application 112, or in another suitable form, etc.

In response, at 304, the mobile device 110 submits a provisioning request to the token host 116. The provisioning request includes the account number for the account, 9434-XXX, an identifier of the issuer processor 106 and a country code, along with a wallet identifier of the wallet application 112 in the mobile device 110. It should be understood that the provisioning request may be submitted directly to the token host 116, or alternatively, may be submitted, by the mobile device 110, through a wallet provider of the wallet application 112 to the token host 116.

The token host 116, in turn, verifies the provisioning request (e.g., the issuer processor 106 is supported, the country code is consistent with a location of the mobile device 110, etc.) and generates, at 306, a pseudo PAN for the 9434-XXX account number. The pseudo PAN is generally an account number associated with and/or supported by the processing network 108. In this specific example, the pseudo PAN includes a BIN 5123, whereby the pseudo PAN is 5123-XXXX-XXXX. In general, the token host 116 (or more generally, the processing network 108) has allocated a BIN range (e.g., 5123-5124, etc.) to the issuer processor 106, whereby pseudo PANs issued by the issuer processor 106 are within that BIN range. It should be appreciated that the BIN may be otherwise in other embodiments. Then, at 308, before generating/assigning a token, the token host 116 identifies the issuer processor 106 based on the identifier, and then, at 310, requests permission to provision the unsupported account associated with the 9434-XXX account number to the mobile device 110. The request included the 5123-XXXX-XXXX pseudo PAN and the 9434-XXX account number.

In this example, at 312, the issuer processor 106 approves the provisioning (e.g., after authenticating the user of the mobile device 110, directly or via the token host 116, etc.). The approval may be indicated by a green indicator back to the token host, or a yellow indicator to provide tentative approval which is subject to authentication of the user by the token host 116, etc. In response, while not shown, the token host 116 authenticates the user by the token host 116 (e.g., via the wallet application 112, an OTP, etc.).

At 314, based on the approval, the token host 116 generates a token for the 5123-XXXX-XXXX pseudo PAN. The token is 5123-YYYY-YYYY, and like the pseudo PAN, in this example, includes a BIN 5123, which is supported by the wallet application 112 and/or consistent with an applicable standard. It should be appreciated that the token and pseudo PAN may be generated at the same time (relative to the approval from the issuer processor 106), in the same or a different order, before or after the approval from the issuer processor 106 in various other examples. At 316, the token host 116 stores the 9434-XXX account number, the 5123-XXXX-XXXX pseudo PAN and the 5123-YYYY-YYYY token, along with the wallet identifier for the wallet application 112 in the mobile device 110, in association, in a record in memory (e.g., memory 204, etc.). The record may be included in a data structure of records for accounts issued by the issuer processor 106, alone or in combination with records for other accounts from other issuer processors, etc. It should be appreciated that the record may include any other suitable data associated with the token, the pseudo PAN, the account, etc.

The token host 116 communicate the 5123-YYYY-YYYY token back to the mobile device 110, at 318, and also communicates the 5123-YYYY-YYYY token to the issuer processor 106, at 320. Because the BIN is supported by the wallet application 112, the mobile device 110 is configured to store the token therein, whereby the 5123-YYYY-YYYY token is provisioned, at 322, to the wallet application 112 in the mobile device 110. In this manner, when the user accesses the wallet application 112 in the mobile device 110, the mobile device 110 is configured, by the wallet application 112, to display the account to the user and to accept selection of the account for use to initiate a transaction.

Further, at 324, the issuer processor 106 is also configured to notify the VAN 104 of the BIN range associated with the issuer processor 106, or the specific 5123-YYYY-YYYY token. In turn, the VAN 104 updates a ledger of BINs and associated issuer processors in memory thereof to include the token and/or the BIN range for the issuer processor 106.

FIG. 4 illustrates an example method 400 for using tokens for an unsupported account (by a mobile device). The example method 400 is described herein in connection with the system 100, and is also described with reference to computing device 200. However, it should be appreciated that the methods herein are not limited to the system 100, or computing device 200. And, likewise, the systems and computing devices described herein are not limited to the example method 400.

At the outset, it should be understood that the 5123-YYYY-YYYY token is provisioned to the mobile device 110 for the unsupported account issued by the issuer processor 106, pursuant to method 300.

With reference to FIG. 4, in connection with a transaction, the mobile device 110 is configured, by the wallet application 112, to provide the 5123-YYYY-YYYY token, at 402, to the first party 102 to fund a transaction by the supported account issued by the issuer processor 106. The mobile device 110 may do so by displaying the account to the user, whereupon the user selects the account. In turn, then, the mobile device 110 transmits a token in response to a tap of the mobile device 110 at a terminal of the first party 102, or displays a QR code indicative of the token to be scanned by the terminal, or otherwise makes the token available to the first party, etc.

The first party 102 receives or captures the token from the mobile device 110. At 404, the first party compiles an authorization request for the transaction, which includes the 5123-YYYY-YYYY token and other transaction details (e.g., amount, first party identifier, country code, currency, time/date, etc.), and at 406, transmits the authorization request to the VAN 104. The VAN 104 in turn identifies, at 408, the issuer processor 106 based on the 5123-YYYY-YYYY token, and specifically, the 5123 BIN thereof, relative to the ledger of BINs and associated issuer processors. At 410, the VAN 104 forwards the authorization request to the issuer processor 106.

The issuer processor 106 identifies the 5123-YYYY-YYYY token, which is not an account number native to the issuer processor 106 (i.e., having a BIN of 9XXX) and communicates, at 412, the authorization request (including the 5123-YYYY-YYYY token) to the access server 118. The access server 118 sends a de-tokenization call, at 414, which includes the 5123-YYYY-YYYY token, to the authorization platform 120, in a form and/or format consistent with de-tokenization calls (as understood by the authorization platform 120). The authorization platform 120 sends the de-tokenization call, at 416, to the token host 116, in a form and/or format consistent with de-tokenization calls (as understood by the token host 116). At 418, the token host 116 identifies the pseudo PAN, i.e., 5123-XXXX-XXXX, for the 5123-YYYY-YYYY token and the account number, i.e., 9434-XXX, and also the wallet identifier specific to the mobile device 110, based on the 5123-YYYY-YYYY token. At 420, the token host 116 forwards the identified pseudo PAN and account number (and wallet identifier) to the authorization platform 120, which forwards, at 422, the identified pseudo PAN and account number to the access server 118.

At 424, the access server 118 compiles and transmits an authorization response to the issuer processor 106. The response includes content as defined in Table 1, in the specific data elements (DE) and sub-elements (SE). The content includes the data identified above and also an on-behalf-of service or OBS result, which may be related to the one or more on-behalf-of services performed by the authorization platform 120 and/or the token host 116. In this example, the OBS result may be indicative of, simply, a successful conversion of a token to an FPAN, while the OBS result may be for other services in other examples.

TABLE 1
DE 2 = 5123-XXXX-XXXX
DE 48.33.2 = 5123 -YYYY-YYYY
DE 48.SE 71 = OBS result(s) (Crypto-
validation)
DE 48. SE 68 = 9434-XXX
DE 48.SE 26 = 123456789

In response, at 426, the issuer processor 106 processes the transaction based on the account number, whereby the issuer processor 106 recognizes the specific account, using the account number 9434-XXX, to which the transaction is directed and further debits the funds for the transaction from the account. And, at 428, the issuer processor 106 submits a response to the VAN 104. The VAN 104, in turn, at 430, sends the response to the first party 102. It should be appreciated that the issuer processor 106 may further indicate a transaction result to the processing network 108, whereby transaction history related to the pseudo PAN and/or the token may be maintained in memory, as necessary or desired.

It should be appreciated that the functions described herein, in some embodiments, may be described in computer executable instructions stored on a computer readable media, and executable by one or more processors. The computer readable media is a non-transitory computer readable media. By way of example, and not limitation, such computer-readable media can include RAM, ROM, EEPROM, CD-ROM or other optical disk storage, magnetic disk storage or other magnetic storage device, or any other medium that can be used to carry or store desired program code in the form of instructions or data structures and that can be accessed by a computer. Combinations of the above should also be included within the scope of computer-readable media.

It should be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the steps of the claims herein, for example: (a) receiving, from a wallet application in a mobile device, a provisioning request to provision a token for an account, the account being unsupported by the wallet application; (b) generating a token for the account; (c) storing the token in a memory in association with an account number for the account; (d) returning the token to the wallet application, whereby the token is stored in the mobile device for use in initiating transactions to the account; (e) generating a pseudo primary account number (PAN) for the account; (f) storing the pseudo PAN in association with the token and the account number for the account; (g) requesting, from an issuer processor, which issued the account, permission to provision the token to the mobile device; (h) receiving permission to provisioning the account to the mobile device from the issuer processor; and/or (i) identifying the issuer processor based on the identifier.

The example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. In addition, advantages and improvements that may be achieved with one or more example embodiments of the present disclosure are provided for purpose of illustration only and do not limit the scope of the present disclosure, as example embodiments disclosed herein may provide all or none of the above mentioned advantages and improvements and still fall within the scope of the present disclosure.

The terminology used herein is for the purpose of describing particular example embodiments only and is not intended to be limiting. As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

The foregoing description of the embodiments has been provided for purposes of illustration and description. It is not intended to be exhaustive or to limit the disclosure. Individual elements, intended or stated uses, or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-based method for use in provisioning and/or using tokens for unsupported accounts, the method comprising:
receiving, by a token host computing device, from a wallet application in a mobile device, a provisioning request to provision a token for an account, the account being unsupported by the wallet application;
generating a token for the account;
storing the token in a memory in association with an account number for the account; and
returning the token to the wallet application, whereby the token is stored in the mobile device for use in initiating transactions to the account.

2. The computer-implemented method of claim 1, wherein the token includes a bank identification number (BIN), which is indicative of a supported account by the wallet application; and
wherein the account is unsupported by the wallet application based on a BIN of the account number.

3. The computer-implemented method of claim 1, further comprising:
generating a pseudo primary account number (PAN) for the account; and
storing the pseudo PAN in association with the token and the account number for the account.

4. The computer-implemented method of claim 3, further comprising:
requesting, from an issuer processor, which issued the account, permission to provision the token to the mobile device; and
receiving permission to provision the token to the mobile device from the issuer processor; and
wherein generating the token for the account includes generating the token for the account based on permission from the issuer processor.

5. The computer-implemented method of claim 4, wherein the provisioning request includes the account number for the account and an identifier of the issuer processor.

6. The computer-implemented method of claim 5, further comprising identifying the issuer processor based on the identifier; and
wherein generating a pseudo PAN for the account is based on a BIN range assigned to the identified issuer processor; and
wherein generating the token includes generating the token based on the pseudo PAN.

7. The computer-implemented method of claim 1, further comprising:
receiving, at the token host computing device, an authorization request for a transaction involving the account, the authorization request including the token;
identifying, by the token host computing device, the account number for the account, in the memory, based on the token; and
transmitting the account number to an issuer processor, which issued the account, whereby the issuer processor uses the account number to process the transaction.

8. A non-transitory computer-readable storage medium comprising executable instructions for use in provisioning and/or using tokens for unsupported accounts, which when executed by at least one processor, cause the at least one processor to:
receive, from a wallet application in a mobile device, a provisioning request to provision a token for an account, the account being unsupported by the wallet application;
generate a token for the account;
store the token in a memory in association with an account number for the account; and
return the token to the wallet application, whereby the token is stored in the mobile device for use in initiating transactions to the account.

9. The non-transitory computer-readable storage medium of claim 8, wherein the executable instructions, when executed by the at least one processor, further cause the at least one processor to:
generate a pseudo primary account number (PAN) for the account; and
store the pseudo PAN in association with the token and the account number for the account.

10. The non-transitory computer-readable storage medium of claim 9, wherein the executable instructions, when executed by the at least one processor, further cause the at least one processor to:
request, from an issuer processor, which issued the account, permission to provision the token to the mobile device; and
receive permission to provision the token to the mobile device from the issuer processor.

11. The non-transitory computer-readable storage medium of claim 10, wherein the executable instructions, when executed by the at least one processor, further cause the at least one processor to identify the issuer processor based on the identifier;
wherein the executable instructions, when executed by the at least one processor to generate the pseudo PAN for the account, cause the at least one processor to generate the pseudo PAN for the account based on a BIN range assigned to the identified issuer processor; and
wherein the executable instructions, when executed by the at least one processor to generate the token for the account, cause the at least one processor to generate the token based on the pseudo PAN.

12. The non-transitory computer-readable storage medium of claim 11, wherein the executable instructions, when executed by the at least one processor to generate the token for the account, cause the at least one processor to generate the token for the account based on permission from the issuer processor.

13. The non-transitory computer-readable storage medium of claim 10, wherein the provisioning request includes the account number for the account and an identifier of the issuer processor.

14. The non-transitory computer-readable storage medium of claim 8, wherein the token includes a bank identification number (BIN), which is indicative of a supported account by the wallet application; and
wherein the account is unsupported by the wallet application based on a BIN of the account number.

15. The non-transitory computer-readable storage medium of claim 8, wherein the executable instructions, when executed by the at least one processor, further cause the at least one processor to:
receive an authorization request for a transaction involving the account, the authorization request including the token;
identify the account number for the account, in the memory, based on the token; and
transmit the account number to an issuer processor, which issued the account, whereby the issuer processor uses the account number to process the transaction.

16. A system for use in provisioning and/or using tokens for unsupported accounts, the system comprising a computing device configured to:
receive, from a wallet application in a mobile device, a provisioning request to provision a token for an account, the account being unsupported by the wallet application;
generate a token for the account;
store the token in a memory in association with an account number for the account; and
return the token to the wallet application, whereby the token is stored in the mobile device for use in initiating transactions to the account.

17. The system of claim 16, wherein the computing device is further configured to:
generate a pseudo primary account number (PAN) for the account; and
store the pseudo PAN in association with the token and the account number for the account.

18. The system of claim 16, wherein the computing device is configured, in order to generate the pseudo PAN for the account, to generate the pseudo PAN for the account based on a BIN range assigned to an issuer processor, which issued the account; and
wherein the computing device is configured, in order to generate the token for the account, to generate the token based on the pseudo PAN.

19. The system of claim 16, wherein the token includes a bank identification number (BIN), which is indicative of a supported account by the wallet application; and
wherein the account is unsupported by the wallet application based on a BIN of the account number.

20. The system of claim 16, wherein the computing device is further configured to:
receive an authorization request for a transaction involving the account, the authorization request including the token;
identify the account number for the account, in the memory, based on the token; and
transmit the account number to an issuer processor, which issued the account, whereby the issuer processor uses the account number to process the transaction.
